(19) United States
(12) Patent Application Publication
(10) Pub. No.: US 2005/0195956 A1
(43) Pub. Date: Sep. 8, 2005

(54) Method and apparatus concerning toll free numbers

(76) Inventor: Sheldon Kass, North Brunswick, NJ (US)

Correspondence Address: Mr. Walter J. Tencza Jr., Suite 3, 10 Station Place, Metuchen, NJ, 08840, US

(21) Appl. No.: 10/792,979

(22) Filed: Mar. 4, 2004

(51) Int. Cl. H04M 3/42

(52) U.S. Cl. 379/207.11

(57) ABSTRACT

A processor is disclosed for receiving a toll free call from a first telecommunications device. The toll free call may be generated by a user dialing a toll free number on the first telecommunications device. The processor may generate a first ring after receiving the toll free call and may transmit the first ring to the first telecommunications device. The processor may determine if a key was pressed on the first telecommunications device following the first ring but before a second ring. If a key was not pressed on the first telecommunications device the processor may allow the toll free call to go through to a second telecommunications device. If a key was pressed the processor may audibly communicate one or more options to the first telecommunications device and may wait for a user of the first telecommunications device to provide a response to the one or more options.

### FIELD OF THE INVENTION

This invention relates to improved methods and apparatus concerning the use of toll free numbers.

### BACKGROUND OF THE INVENTION

The preponderance of toll free numbers are used to allow people to call a business at no charge. Toll free numbers also may be used for calling cards. Normally, one toll free number is used to receive calls while a different toll free number may be used to make calls through a calling card.

### SUMMARY OF THE INVENTION

The present invention, in one or more embodiments, provides a single toll free number for both receiving calls and making calls. Additionally a host of other features may be included with the use of the same toll free number. These additional features may include voice mail, recording conversations, web reporting of calls, web listening to calls, user control of changing greetings and changing certain parameters and a user-friendly security system.

The present invention in one or more embodiments provides an apparatus comprising a processor. The processor may receive a toll free call from a first telecommunications device. The toll free call may be generated by a user dialing a toll free number on the first telecommunications device. The processor may generate a first ring after receiving the toll free call and may transmit the first ring to the first telecommunications device. The processor may determine if a key was pressed on the first telecommunications device following the first ring but before a second ring.

If a key was not pressed on the first telecommunications device the processor may allow the toll free call to go through to a second telecommunications device. If a key was pressed the processor may audibly communicate one or more options to the first telecommunications device and may wait for a user of the first telecommunications device to provide a response to the one or more options.

The one or more options may be comprised of an audible request from the processor to the first telecommunications device for the user of the first telecommunications device to enter a password into the first telecommunications device. The one or more options may be comprised of an audible request from the processor to the first telecommunications device for the user of the first telecommunications device to enter a telephone number to call.

The processor may play back voice mail messages to the first telecommunications device. The processor may route future calls to the toll free number to the first telecommunications device. The processor may route future calls to the toll free number to a further telephone number, wherein the further telephone number is stored in a memory of the processor. The processor may route future calls to the toll free number to a further telephone number entered by a user into the first telecommunications device. The processor may cause data concerning the toll free call to be displayed on an Internet web page.

In one or more embodiments, the processor may receive a toll free call from a first telecommunications device having a first telephone number. The toll free call may be generated by dialing a toll free number on the first telecommunications device. The processor may determine if the first telephone number is on a nuisance list. If the first telephone number is on the nuisance list then the processor may cause the toll free call to be automatically routed to voice mail. If the first telephone number is not on the nuisance list, then the processor may cause the toll free call to be routed to a second telecommunications device.

In one or more embodiments, the processor may receive an input from a second telecommunications device indicating that a telephone number should be placed on a nuisance list in a memory of the processor.

### BRIEF DESCRIPTION OF THE DRAWINGS

FIG. 1 shows a block diagram of an apparatus for use in accordance with one or more embodiments of the present invention;

FIG. 2 shows a flow chart concerning processing of a user's initial set up call;

FIG. 3A shows a flow chart dealing with processing of a toll free call;

FIG. 3B shows a flow chart dealing with processing of a user's entry of one or more keys;

FIG. 4 shows a flow chart concerning processing for an outbound call;

FIG. 5 shows a flow chart concerning a main menu;

FIG. 6 shows a flow chart concerning a phone functions menu;

FIG. 7 shows a flow chart concerning a user functions menu;

FIG. 8 shows a flow chart concerning a maintenance menu;

FIG. 9 shows a flow chart concerning a guided complete installation menu;

FIG. 10 shows a continuation of a flow chart for a guided complete installation menu;

FIG. 11 shows a flow chart concerning processing for voice mail;

FIG. 12 shows a flow chart concerning processing for causing calls to a toll free number to be redirected to a current phone;

FIG. 13 shows a flow chart concerning processing for causing calls to a toll free number to be redirected to a telephone number to be entered by a user;

FIG. 14 shows a flow chart concerning processing for causing calls to a toll free number to be redirected to one of a plurality of telephone numbers listed in a table;

FIG. 15 shows a flow chart concerning processing for causing calls to a toll free number to be redirected to a telephone number to be entered by a user;

FIG. 16 shows a flow chart concerning processing relating to the # or the * keys;

FIG. 17 shows a flow chart concerning storing a call record and making a recorded conversation available;

FIG. 18 shows a menu for logging into a system for retrieving information about telephone calls and conversations;

FIG. 19 shows a menu for selecting a report type and for inputting other criteria for displaying information about telephone calls and conversations; and

FIG. 20 shows a menu for a report type concerning telephone calls and conversations.

### DETAILED DESCRIPTION OF THE DRAWINGS

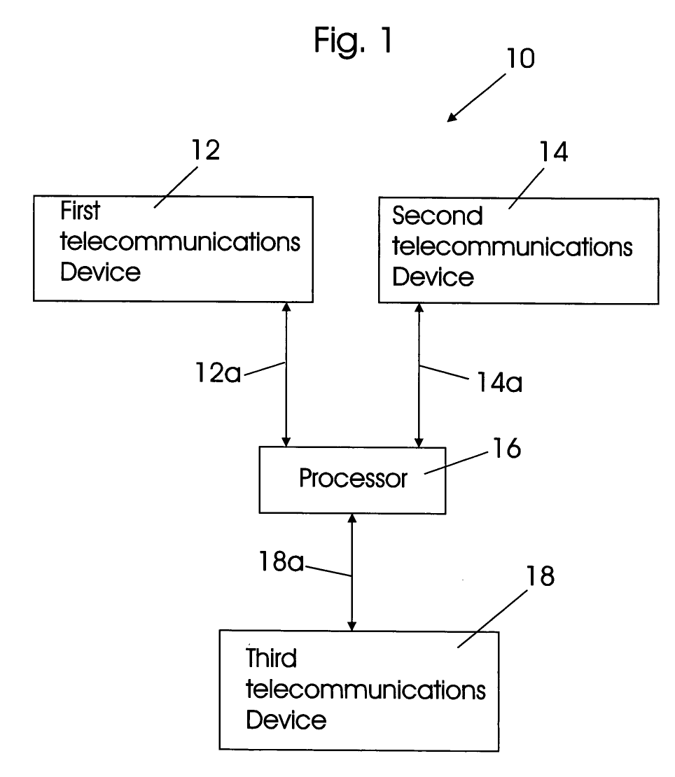

FIG. 1 shows a block diagram of an apparatus 10 for use in accordance with one or more embodiments of the present invention. The apparatus 10 is comprised of first, second, and third telecommunications devices 12, 14, and 18, respectively, and a processor 16. The processor 16 is electrically connected to the first, second, and third telecommunications devices 12, 14, and 18 via communications links 12a, 14a, and 18a, respectively. The telecommunications links may be wireless, hardwired, optical, or any other type or combination of telecommunications links. The first, second, and third telecommunications devices 12, 14, and 18 each may be, for example, standard or wireless telephones. The devices 12, 14, and 18 are typically different telecommunications devices, such as different telephones. The processor 16 may be a computer, such as a personal computer, which may include memory, a monitor, and an interactive device, such as a computer keyboard and/or a computer mouse.

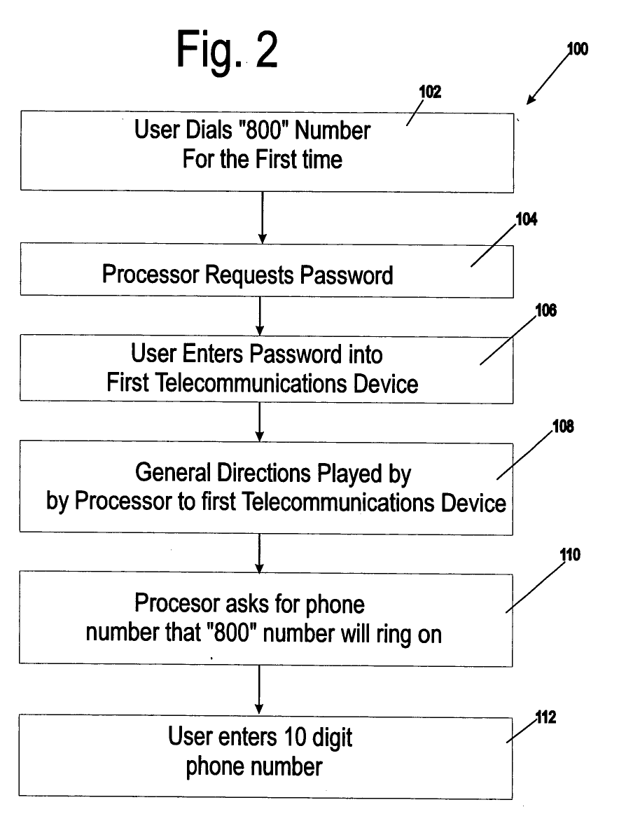

FIG. 2 shows a flow chart 100 concerning processing of a user's initial set up call for an “800” or toll free number in accordance with one or more embodiments of the present invention. At step 102 a user, dials a special “800” number for the first time, for example by dialing the “800” number onto telecommunications device 12 of FIG. 1. At step 104, the processor 16 receives the call from the telecommunications device 12 and requests a password from the telecommunications device 12. The user enters a password into the first telecommunications device 12 at step 106. The processor 16 receives the password, and if the password is valid, the processor 16 plays audio directions and transmits these to the telecommunications device 12 at step 108. These general directions may provide the user with information about the user's “800” number. At step 110, the processor 16 may ask the user (at telecommunications device 12) to enter the phone number that the “800” number will ring on, when another party calls the “800” number (and when no other options are selected as will be described). The user enters a ten digit telephone number at step 112 into telecommunications device 12.

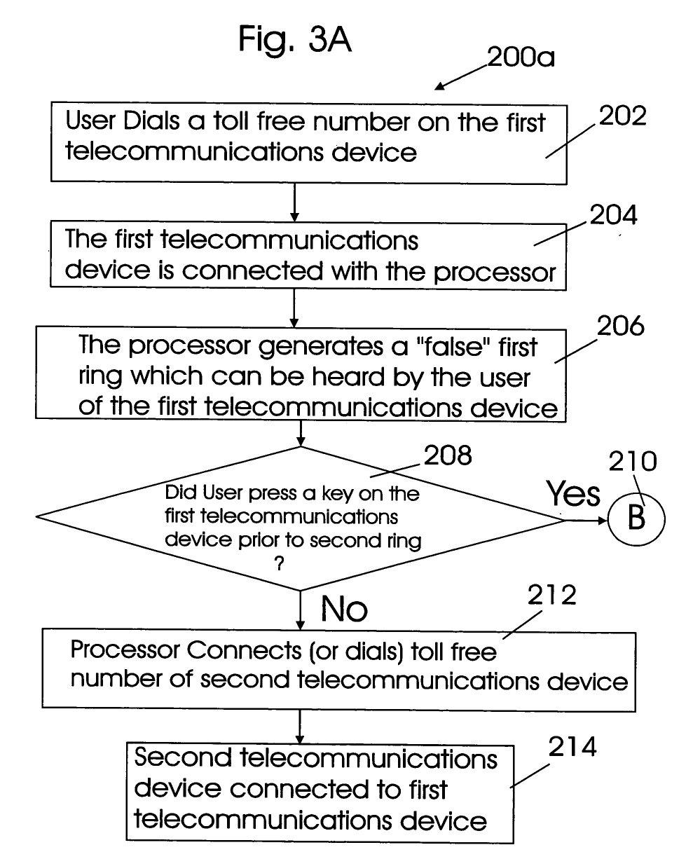

FIG. 3A shows a flow chart 200a dealing with processing of a toll free call in accordance with an embodiment of the present invention, after the procedure of FIG. 2 has been carried out. At step 202 a user of, for example, the first telecommunications device 12 may dial the special toll free number on the first telecommunications device 12. The toll free number may be dialed in any manner, such as by pressing a series of keys or speaking the phone number. At step 204, the processor 16 receives the toll free phone call from the first telecommunications device 12 via the communications link 12a. At step 206, the processor 16 generates a false first audible ring, which is sent via the communications link 12a and is received by the first telecommunications device 12 and can be heard by the user.

The user must then decide whether to let the toll free call proceed to a particular destination (currently the ring to destination entered in step 112 of FIG. 2) or to select another option. If the user does not provide an entry via the first telecommunications device 12 to the processor 16 prior to a second ring, then at steps 212 and 214 the processor 16 connects the second telecommunications device 14 to the first telecommunications device 12 and allows the call from the device 12 to the device 14 to go through. This assumes that the second telecommunications device 14 has a phone number that was entered as the ten digit number in step 112 of FIG. 2 or during another procedure as will be described later. If the user provides an entry via the first telecommunications device 12 to the processor 16 prior to a second ring, then the method proceeds to step 210 and the processor 16 executes one of several options depending upon the entry.

Typically the entry by the user will be the pressing of one or more keys on the telecommunications device 12. FIG. 3B shows a flow chart 200b dealing with processing of a user's entry of one or more keys in accordance with an embodiment of the present invention. If the user pressed the “1” key on the telecommunications device 12 then the outbound call processing is entered through steps 214, and step 300. If the user pressed the “2” key on the telecommunications device 12 then main menu processing is entered at step 402. If the user pressed the “3” key on the telecommunications device 12 the voice mail processing is entered through steps 218 and 1000. If the user pressed the “4” key on the telecommunications device 12 then “follow to current phone” processing is entered through steps 220 and 400. If the user pressed the “5” key, then the “6” key, then the “follow to phone to be entered” processing is entered through steps 230 and 1200. If the user pressed the “6” key and then the “4” key then “follow to phone in table” processing is entered through step 232 and step 1300. If the user pressed the “7” key at step 233 then the “phone functions menu” processing is entered through step 233 and 502. If the user pressed the “8” key at step 234 then the “user functions menu” processing is entered through step 800. If the user pressed the “9” key, then the “main menu” is entered through steps 235 and 1602.

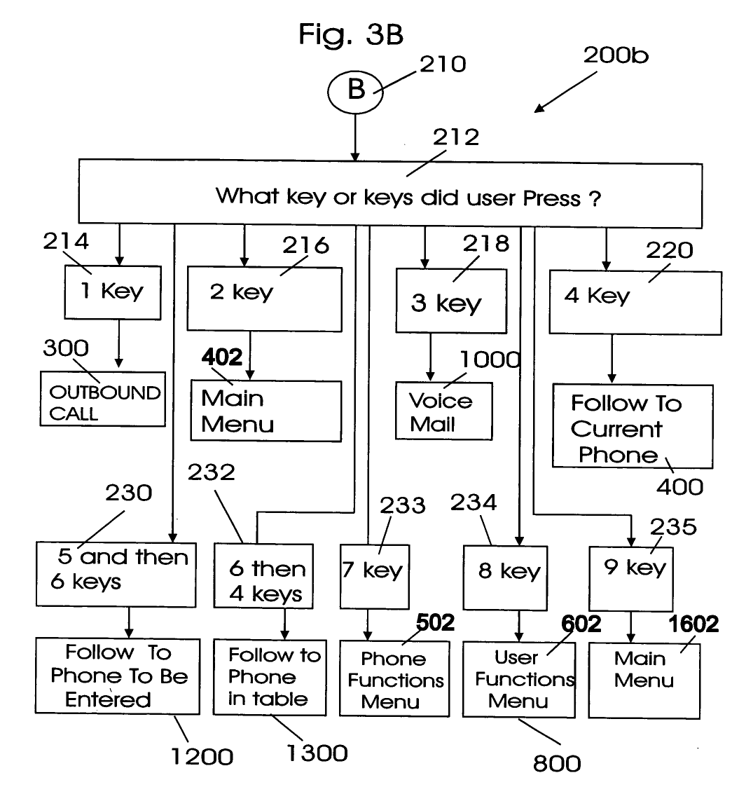

FIG. 4 shows a flow chart concerning processing for an outbound call which is entered into through step 300. At step 302 the processor 16 requests a password from the user of the first telecommunications device 12. The step of requesting a password may be eliminated in some cases. The request may be in the form of an audible message sent from the processor 16 to the first telecommunications device 12 via the communications link 12a. The user then must enter a valid password or code into the first telecommunications device 12 such as by typing one or more numbered keys. The password is sent to the processor 16 via communications link 12a. The processor 16 determines if the password is valid at step 304. If the password is not valid, the processor 16 terminates the call at step 306.

If the password is valid the processor 16 next requests a ten digit telephone number from the user, at step 308. This can also be requested via an audible message sent from the processor 16 to the first telecommunications device 12 via the communications link 12a. At step 310, the user may then enter a ten digit number into the telecommunications device 12, which is sent to the processor 16 via the link 12a. The processor 16 receives the number and dials it and/or connects the first telecommunications device 12 with, for example, a third telecommunications device 18, at step 312.

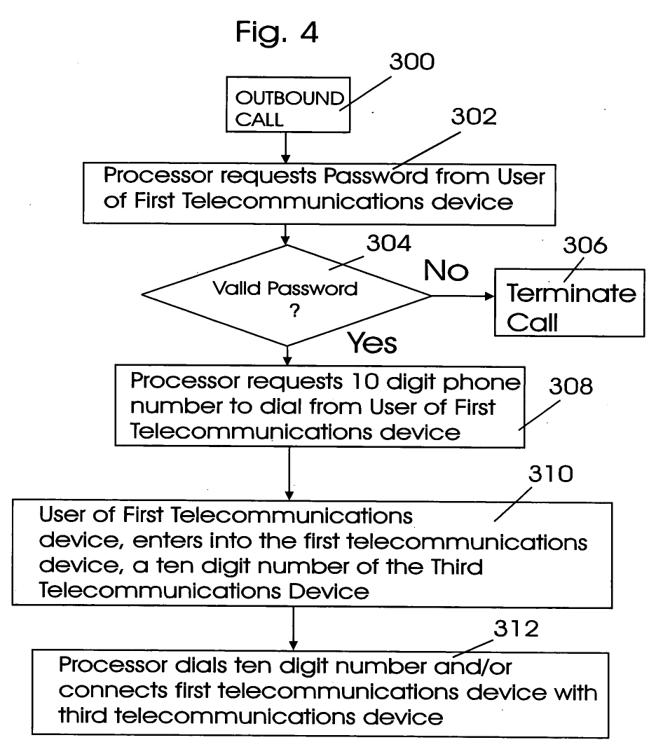

FIG. 5 shows a flow chart 400 concerning processing for a main menu. At step 402 the main menu is entered. The processor 16 may provide an audible message to the telecommunications device 12 over link 12a that the main menu has been entered. At step 404 the processor 16 may provide an audible message to telecommunications device 12 over link 12a of a choice of keys to press and the processing or category, which may be activated by pressing a particular key.

If the user presses the “1” key on the telecommunications device 12, a signal will be sent to the processor 16 via communications link 12a, and processing for the phone functions menu may be entered through steps 406 and 502. If the user presses the “2” key on the telecommunications device 12, a signal will be sent to the processor 16 via communications link 12a, and processing for the maintenance menu may be entered through steps 410 and 702. If the user presses the “3” key on the telecommunications device 12, a signal will be sent to the processor 16 via communications link 12a, and processing for an audible system description provided by the processor 16 may be entered through steps 414 and 416. If the user presses the “4” key on the telecommunications device 12, a signal will be sent to the processor 16 via communications link 12a, and processing for a “guided complete installation” may be entered through steps 418 and 802. If the user presses the “5” key on the telecommunications device 12, a signal will be sent to the processor 16 via communications link 12a, and processing for a “main menu” may be entered or repeated through 422 and 402.

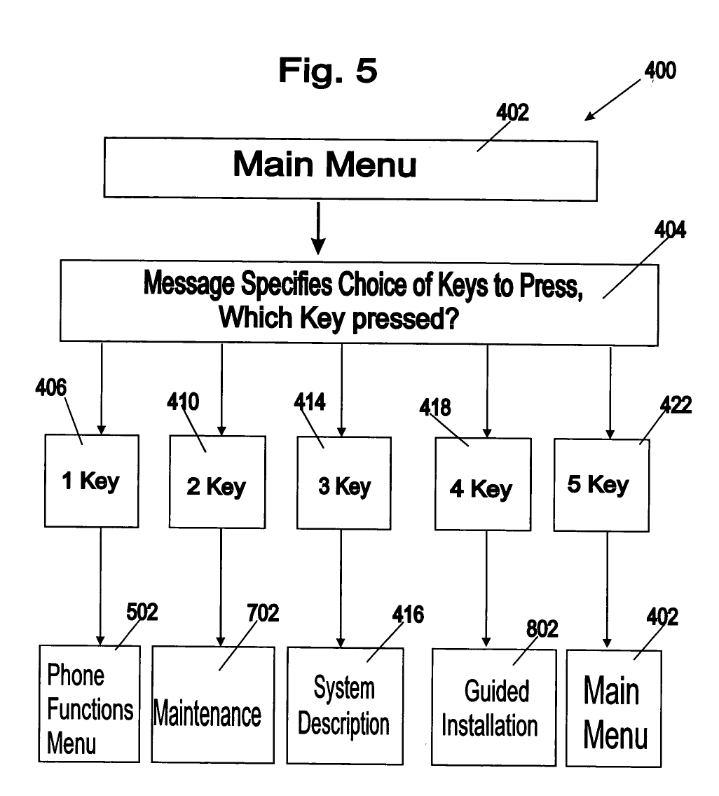

FIG. 6 shows a flow chart 500 concerning processing for the phone functions menu. At step 502 the phone functions menu 500 is entered. The processor 16 may provide an audible message to the telecommunications device 12 over link 12a that the phone functions menu has been entered. At step 504 the processor 16 may provide an audible message to telecommunications device 12 over link 12a of a choice of keys to press and the processing or category, which may be activated by pressing a particular key.

If, while in the phone functions menu, the user presses the “1” key on the telecommunications device 12, a signal will be sent to the processor 16 via communications link 12a, and the user will be able to hear all the recorded conversations recorded for the special “800” number, through steps 506 and 508. The conversations stored within memory of the processor 16 and can be played back and transmitted to the telecommunications device 12.

If the user presses the “2” key on the telecommunications device 12, while in the phone functions menu, a signal will be sent to the processor 16 via communications link 12a, and the user will be able to allow another person to listen to a recorded call through steps 510 and 512.

If the user presses the “7” key on the telecommunications device 12, while in the phone functions menu, a signal will be sent to the processor 16 via communications link 12a, and the phone functions menu will be repeated or reentered by the processor 16 through steps 514 and 502.

If the user presses the “8” key on the telecommunications device 12, while in the phone functions menu, a signal will be sent to the processor 16 via communications link 12a, and the user functions menu processing will be entered through steps 518 and 602.

If the user presses the “9” key on the telecommunications device 12, while in the phone functions menu, a signal will be sent to the processor 16 via communications link 12a, and the main menu processing will be entered through steps 522 and 402.

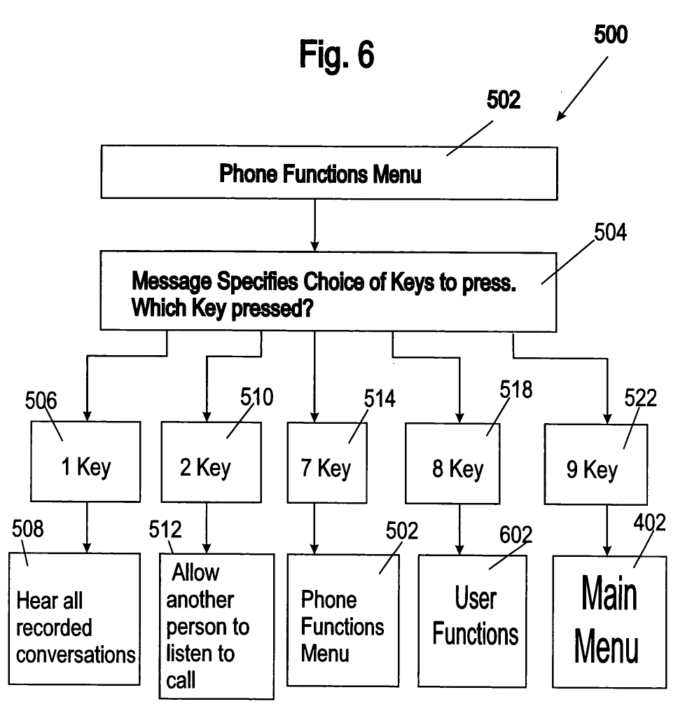

FIG. 7 shows a flow chart 600 concerning processing for the user functions menu. The user functions menu processing begins at step 602. At step 604 the processor 16 sends an audible message to the telecommunications device 12 providing a list of different keys to press and the processing, which will be executed by the processor 16 for each key. The processor 16 waits for a user of telecommunications device 12 to press a key on the telecommunications device 12.

If the user presses the “1” key on the telecommunications device 12, while in the user functions menu, a signal will be sent to the processor 16 via communications link 12a, and in response the processor 16 will provide a message, typically audible, to the telecommunications device 12 for the user to enter a number for an outbound call, through steps 606 and 608. In response to the user's entry of the number for an outbound call, the processor 16 may dial the number or connect a telecommunications device, such as device 18 to the telecommunications device 12.

If the user presses the “2” key on the telecommunications device 12, while in the user functions menu, a signal will be sent to the processor 16 via communications link 12a, and in response the processor 16 will play the user's voice mail which was previously stored in memory of the processor 16 through steps 610 and 612. The user's voice mail is played and transmitted from the processor 16 to the telecommunications device 12 via communications link 12a.

If the user presses the “3” key on the telecommunications device 12, while in the user functions menu, a signal will be sent to the processor 16 via communications link 12a, and in response the processor 16 will play the user's recorded conversations which were previously stored in memory of the processor 16 through steps 614 and 616. The user's recorded conversations are played and transmitted from the processor 16 to the telecommunications device 12 via communications link 12a.

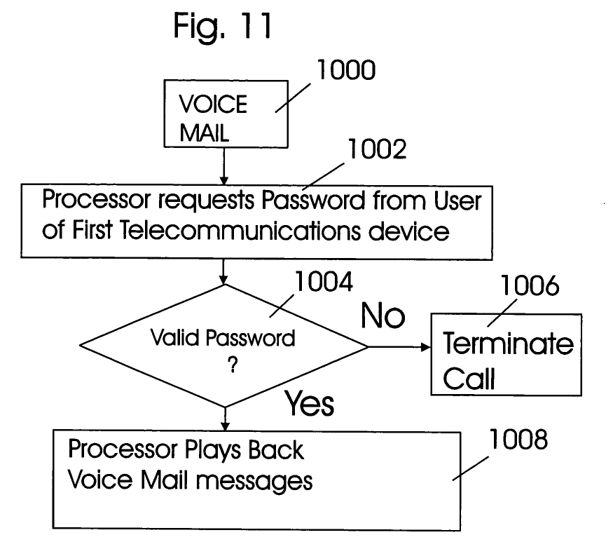

If the user presses the “4” key on the telecommunications device 12, while in the user functions menu, a signal will be sent to the processor 16 via communications link 12a, and in response the processor 16 will cause the current phone (i.e. telecommunications device 12) to ring when someone calls the special “800” number, through step 618 and the processing starting with step 1100, which is shown in FIG. 12. The request for password in FIG. 12 is optional.

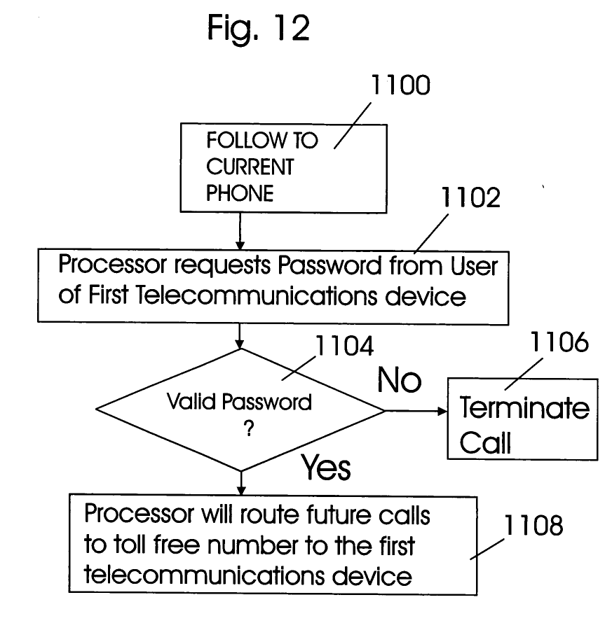

If the user presses the “5” key on the telecommunications device 12, while in the user functions menu, a signal will be sent to the processor 16 via communications link 12a. In response the processor 16 will execute processing concerning the current phone (i.e. telecommunications device 12) to ring when someone calls the special “800” number, through step 622 and the processing starting with step 1200, which is also shown in FIG. 13. The request for password in FIG. 13 is optional.

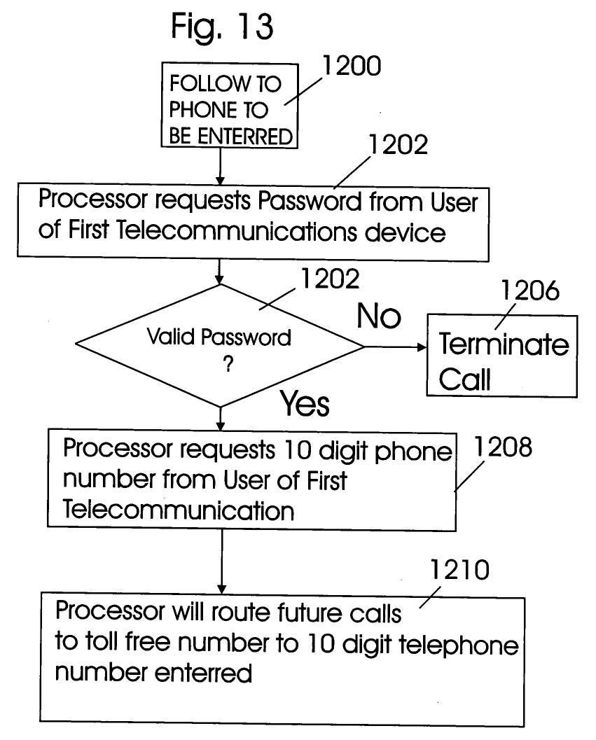

If the user presses the “6” key on the telecommunications device 12, while in the user functions menu, a signal will be sent to the processor 16 via communications link 12a. In response the processor 16 will execute processing concerning ringing or following to a phone number in a table in memory of the processor 16, through steps 626 and processing starting with step 1300, which is also shown in FIG. 14. The request for password in FIG. 14 is optional.

If the user presses the “7” key on the telecommunications device 12, while in the user functions menu, a signal will be sent to the processor 16 via communications link 12a. In response the processor 16 will execute processing which will play audible messages to the telecommunications device 12 regarding more options for the user, through steps 630 and 632.

If the user presses the “8” key on the telecommunications device 12, while in the user functions menu, a signal will be sent to the processor 16 via communications link 12a. In response the processor 16 will cause the user functions menu processing to repeat through steps 634 and 602.

If the user presses the “9” key on the telecommunications device 12, while in the user functions menu, a signal will be sent to the processor 16 via communications link 12a. In response the processor 16 will cause the main menu processing to repeat through steps 638 and 402. Step 402 is also shown in FIG. 5.

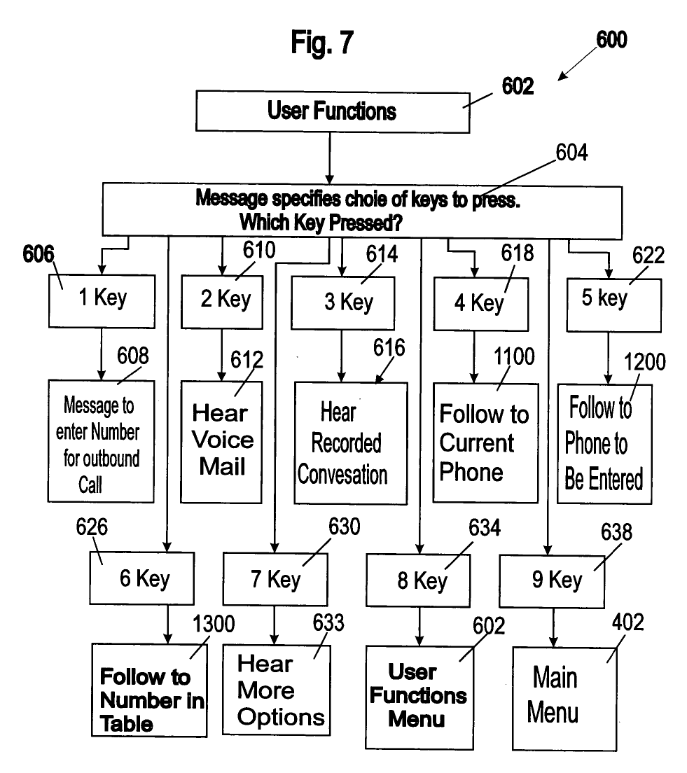

FIG. 8 shows a flow chart 700 concerning processing for maintenance. The maintenance processing begins at step 702. At step 704 the processor 16 sends an audible message to the telecommunications device 12 providing a list of different keys to press and the processing, which will be executed by the processor 16 for each key. The processor 16 waits for a user of telecommunications device 12 to press a key on the telecommunications device 12.

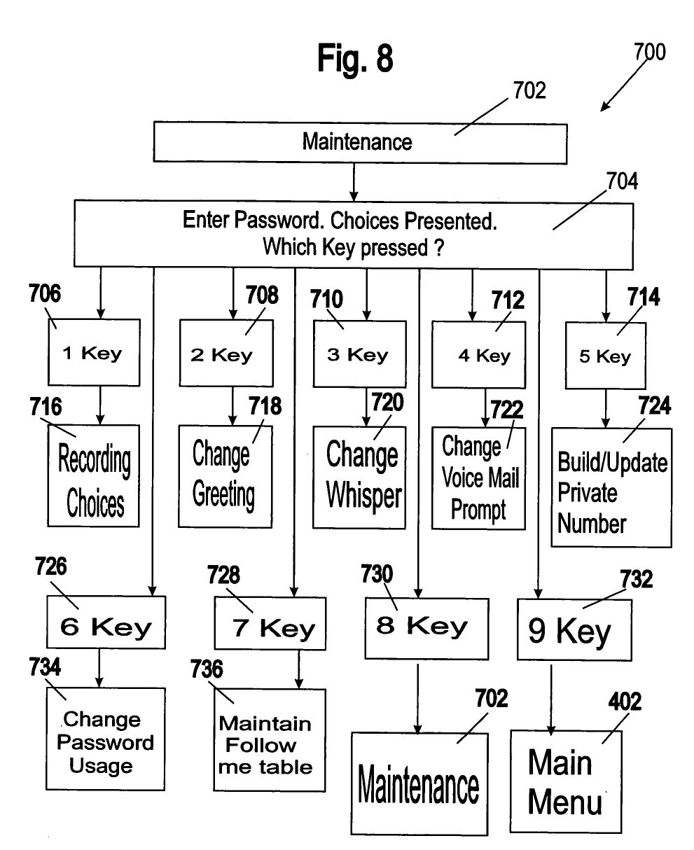

If the user presses the “1” key on the telecommunications device 12, while the processor 16 is in the maintenance processing, a signal will be sent to the processor 16 via communications link 12a. In response, the processor 16 will provide messages, typically audible, to the telecommunications device 12, concerning recording choices for the user, through steps 706 and 716. The recording choices processing starting at step 716 may include the guided complete installation processing shown in FIG. 9, to be described later.

If the user presses the “2” key on the telecommunications device 12, while the processor 16 is in the maintenance processing shown in FIG. 8, a signal will be sent to the processor 16 via communications link 12a. In response, the processor 16 will provide messages, typically audible, to the telecommunications device 12, concerning changing of the regular greeting for the special “800” number, through steps 708 and 718. The regular greeting is played to someone who calls the “800” number, when for example, the “800” number is busy.

If the user presses the “3” key on the telecommunications device 12, while the processor 16 is in the maintenance processing shown in FIG. 8, a signal will be sent to the processor 16 via communications link 12a. In response, the processor 16 will provide messages, typically audible, to the telecommunications device 12, concerning changing of the “whisper” feature for the special “800” number, through steps 710 and 720. The “whisper” feature may provide a user of the telecommunications device 12 with information about a caller that is calling the “800” number. For example, if telecommunications device 18 calls the “800” number and the “800” is directed towards the telecommunications device 12, then the whisper feature may require the processor 16 to play and transmit to the telecommunications device 12 information about the prior recording, caller name (associated with device 18), and opinion (of user of device 12) of last call from device 18. The “whisper” information may be played only to the user of device 12, so that the user can be better informed prior to speaking to the caller from device 18 or make a decision about whether to talk to the caller from device 18 at all. The processor 16 may cause a beep at the end of the “whisper” and thereafter may permit the devices 12 and 18 to communicate.

If the user presses the “4” key on the telecommunications device 12, while the processor 16 is in the maintenance processing, a signal will be sent to the processor 16 via communications link 12a. In response, the processor 16 will provide messages, typically audible, to the telecommunications device 12, concerning changing the voice mail prompt, through steps 712 and 722. The user of device 12 may then change the voice mail prompt by pressing appropriate keys or otherwise entering appropriate information on the device 12.

If the user presses the “5” key on the telecommunications device 12, while the processor 16 is in the maintenance processing, a signal will be sent to the processor 16 via communications link 12a. In response, the processor 16 will provide messages, typically audible, to the telecommunications device 12, concerning building or updating private numbers through steps 714 and 724. The user of device 12 may enter or update information concerning private numbers by pressing appropriate keys or otherwise entering appropriate information on the device 12. Private numbers are phone numbers from which the user can dial and which do not require a password to be entered. Private phone numbers can be stored in memory of the processor 16.

If the user presses the “6” key on the telecommunications device 12, while the processor 16 is in the maintenance processing, a signal will be sent to the processor 16 via communications link 12a. In response, the processor 16 will provide messages, typically audible, to the telecommunications device 12, concerning changing password usage, through steps 726 and 734. The user of device 12 may enter or update information concerning password usage by pressing appropriate keys or otherwise entering appropriate information on the device 12.

If the user presses the “7” key on the telecommunications device 12, while the processor 16 is in the maintenance processing, a signal will be sent to the processor 16 via communications link 12a. In response, the processor 16 will provide messages, typically audible, to the telecommunications device 12, concerning maintaining the follow me table or the telephone numbers of the follow me table through steps 728 and 736. The user can cause the special “800” number to ring on any phone number of the follow me table through processing shown in FIG. 14, which can be entered for, for example, through the user functions menu processing of FIG. 7.

If the user presses the “8” key on the telecommunications device 12, while the processor 16 is in the maintenance processing, a signal will be sent to the processor 16 via communications link 12a. In response, the processor 16 restart the maintenance menu processing through steps 730 and 702.

If the user presses the “9” key on the telecommunications device 12, while the processor 16 is in the maintenance processing, a signal will be sent to the processor 16 via communications link 12a. In response, the processor 16 will restart the main menu processing (shown in FIG. 5) through steps 732 and 402.

FIG. 9 shows a flow chart 800 concerning processing for guided installation. The guided installation processing begins at step 802. At step 804 the processor 16 sends an audible message to the telecommunications device 12 providing a list of different keys to press and specifies the processing which will be executed by the processor 16 for each key. The processor 16 waits for a user of telecommunications device 12 to press a key on the telecommunications device 12.

The guided installation processing of FIG. 9 provides recording options. There is a legality issue to be aware of when recording telephone conversations. The specific laws vary by state. Every state requires that at least one party to a two party conversation be aware that the call is being recorded. Twelve states require that both parties are aware of the fact that the call is being recorded. A solution presented by the present application, provides for a series of choices that vary the notification to inbound callers and, and at the same time only records the calls that meet the legal requirements of the call under consideration.

Considering inbound calls, if the caller is from a one party state, then the processor 16 can set a greeting “A” which does not inform the caller that the call is being recorded. (i.e. the “800” number owner already knows the call is being recorded satisfying the legal requirement of the one party state.). A greeting “B” can be played if the caller is from a two party state. Greeting “B” may inform the caller that the call is being recorded (to satisfy the requirement of two parties being aware). The processor 16 can automatically determine what state the caller is from the caller's identification number.

Concerning outbound calls, the processor 16 may have a separate parameter that determines which outbound calls are to be recorded. The processor 16 would know what state the person is being called from, as well as the state that is being called. The processor may provide appropriate audible messages to one or more parties to the call in order to comply with legal requirements.

If the user presses the “1” key on the telecommunications device 12, while the processor 16 is in the guided installation processing, a signal will be sent to the processor 16 via communications link 12a. In response, the processor 16 will record in its memory that inbound calls to the “800” number should not be recorded through steps 806 and 808. Processing similar to that shown in steps 804-828 will then be available to be used for outbound calls through steps 830 and 832.

If the user presses the “2” key on the telecommunications device 12, while the processor 16 is in the guided installation processing, a signal will be sent to the processor 16 via communications link 12a. In response, the processor 16 will record in its memory that all inbound calls to the “800” number should be recorded through steps 810 and 812. Processing similar to that shown in steps 804-828 will then be available to be used (and executed depending on what key is pressed) for outbound calls through steps 830 and 832.

If the user presses the “3” key on the telecommunications device 12, while the processor 16 is in the guided installation processing, a signal will be sent to the processor 16 via communications link 12a. In response, the processor 16 will record in its memory that all inbound calls to the “800” number from a “one party state” (i.e. a state where only one party needs to be aware that a call is being recorded for recording of a call to be legal) should be recorded through steps 814 and 816. Processing similar to that shown in steps 804-828 will then be available to be used (and executed depending on what key is pressed) for outbound calls through steps 830 and 832.

If the user presses the “4” key on the telecommunications device 12, while the processor 16 is in the guided installation processing, a signal will be sent to the processor 16 via communications link 12a. In response, the processor 16 will record in its memory that all inbound calls to the “800” number where a “4” key is pressed at the end of the call should be recorded through steps 818 and 820. Processing similar to that shown in steps 804-828 will then be available to be used (and executed depending on what key is pressed) for outbound calls through steps 830 and 832.

If the user presses the “5” key on the telecommunications device 12, while the processor 16 is in the guided installation processing, a signal will be sent to the processor 16 via communications link 12a. In response, the processor 16 will record in its memory that all inbound calls to the “800” number from a “one party state” and where a “4” key is pressed at the end of the call should be recorded through steps 822 and 824. Processing similar to that shown in steps 804-828 will then be available to be used (and executed depending on what key is pressed) for outbound calls through steps 830 and 832.

If the user presses the “6” key on the telecommunications device 12, while the processor 16 is in the guided installation processing, a signal will be sent to the processor 16 via communications link 12a. In response, the processor 16 will record in its memory that all inbound calls to the “800” number from a “one party state” and where a “4” key is pressed at the end of the call should be recorded through steps 826 and 828. In addition this option provides that when the “4” key is pressed, an alert, or audible message, will be provided at the end of a “two party state” call (i.e. an inbound call from a state where two parties must be aware of the fact that the call is recording). The alert will ask the user whether he or she wants the call recorded. Processing similar to that shown in steps 804-828 will then be available to be used (and executed depending on what key is pressed) for outbound calls through steps 830 and 832.

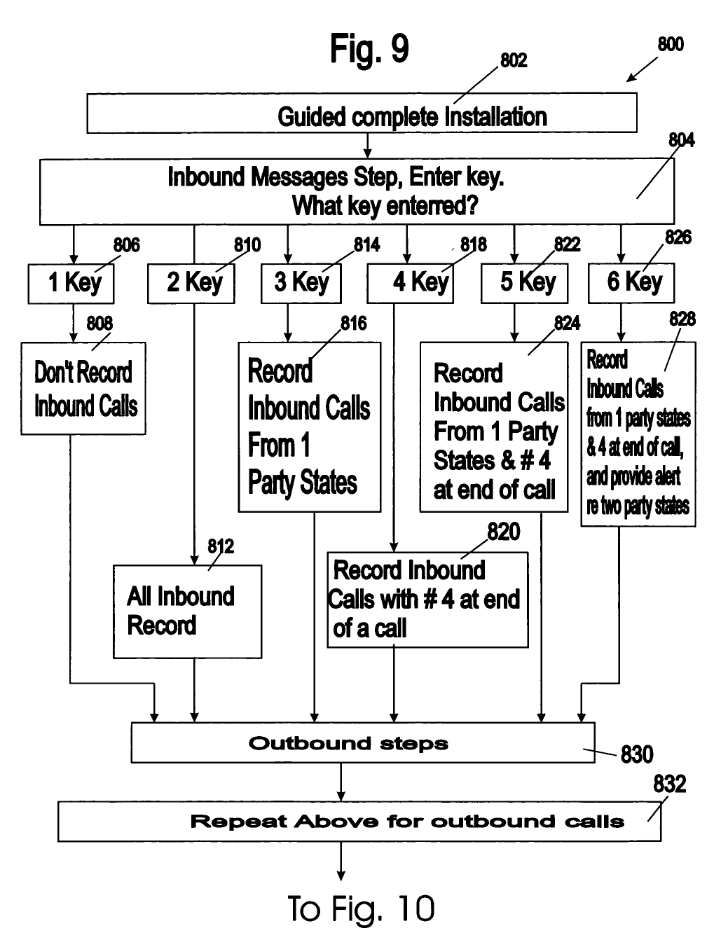

FIG. 10 shows a continuation 900 of the flow chart 800 for a guided installation menu processing of FIG. 9. After the procedure of recording or not recording of inbound and outbound calls has been determined and stored in the memory of processor 16, the user can set “ring seconds” for the “800” number at step 902. The user may change the number of ring seconds that the appropriate telephone, such as for example first telecommunications device 12, rings before a call goes to voice mail. The number of ring seconds is important because it controls whether the voice mail for a call rests with this toll free service or with the phone that is dialed by the toll free service. The user may change the number of ring seconds by entering data into, for example, telecommunications device 12.

Next at step 904, the user can record a new greeting in the memory of the processor 16, by entering the new greeting into the telecommunications device 12 and link 12a. At step 906 the user can record a nuisance greeting into the memory of the processor 16, by entering the new greeting into the telecommunications device 12 and link 12a. At step 908 the user can enter private phone information into the memory of the processor 16 through the telecommunications device 12 and link 12a.

The user can reduce the need to key in the user's password for each phone call by setting up a list of 10 digit private phone numbers of telecommunications devices that the user routinely uses, such as an office telephone, cell telephone, or home telephones. This list may be called the user's private phone list and may be stored in a memory of the processor 16. When the user dials a toll free number from a private telephone, the user will typically not hear the phone ringing, instead the user will hear a dial tone and typically the user will not be asked for a password.

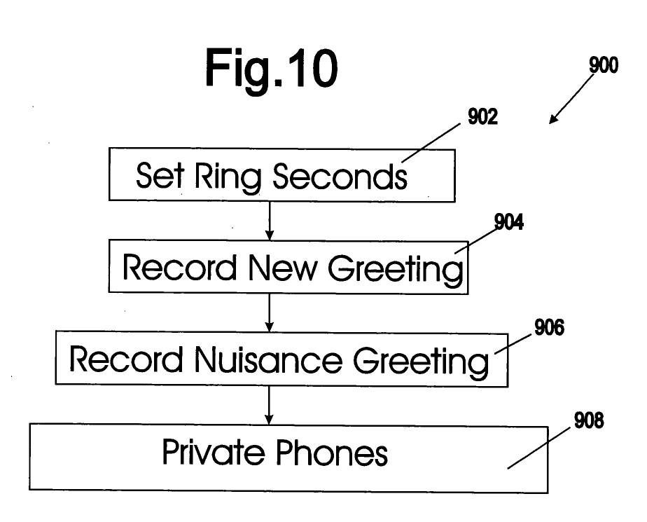

FIG. 11 shows a flow chart concerning processing for playing back voice mail, which is entered into via step 1000. At step 1002, the processor 16 requests a password from a user of first telecommunications device 12, via, for example, an audible message sent over communications link 12a from processor 12 to telecommunications device 12. The user may then enter a series of numbers for a password or code into the first telecommunications device 12. The processor 16 receives the code or password and determines if it is valid, at step 1004. If the password is not valid, the processor 16, terminates the call at step 1006. At step 1008 the processor 16 plays back voice mail messages, which may be stored in memory of the processor 16. The voice mail data can be retrieved from the processor 16's memory and sent out over the communications link 12a to the telecommunications device 12.

FIG. 12 shows a flow chart concerning processing for causing calls to a toll free number to be redirected to a current phone, which is entered at step 1100. This can be called one type of a follow me feature. FIGS. 13 and 14 show other types of a follow me feature. At step 1102, the processor 16 requests a password from the user of the first telecommunications device 12. Similar to the method shown by the flow chart of FIG. 11, the processor 16 receives a password from the first telecommunications device 12 and determines whether the password is valid at step 1104. If the password is not valid, the processor 16 terminates the call at step 1106. At step 1108 the processor 16 will cause future calls to the toll free number to be routed to the current phone, i.e. telecommunications device 12. For example, a future call to the toll free number from the second telecommunications device 14 would be automatically routed by the processor 16 to the telecommunications device 12.

FIG. 13 shows a flow chart concerning processing for causing calls to a toll free number to be redirected to a telephone number to be entered by a user. The method in FIG. 13 is entered into at step 1200. Similar to FIG. 11 and 12, at steps 1202 and 1204, the processor requests and password and determines if the password is valid, and if the password is not valid the call is terminated at step 1206. If the password is valid the processor 16 requests a ten digit phone number from the user of the first telecommunications device 12, at step 1208. The user may then enter ten digit number, by for example, pressing a series of numbered keys, on the first telecommunications device 12. The processor 16 will route future calls to the toll free number to the user entered ten digit number at step 1210. For example, if the user entered the number of third telecommunications device 18, then the processor 16 would route future calls to the toll free number to the phone number of the third telecommunications device 18.

FIG. 14 shows a flow chart concerning processing for causing calls to a toll free number to be redirected to one of a plurality of telephone numbers listed in a table. The flow chart in FIG. 14 is entered at step 1300. At step 1302, the processor 16 requests a password from a user of the first telecommunications device 12. Similar to the methods shown by FIGS. 11, 12, and 13, the processor 16 receives a password from the device 12 and determines if it is valid at step 1304. If the password is not valid, the call is terminated at step 1306. If the password is valid, then at step 1308 the processor 16 will route future calls to the toll free number to a telephone number in a table in the memory of the processor 16. For example, a future call to the toll free number from the second telecommunications device 14 may be automatically routed to a third telecommunications device 18.

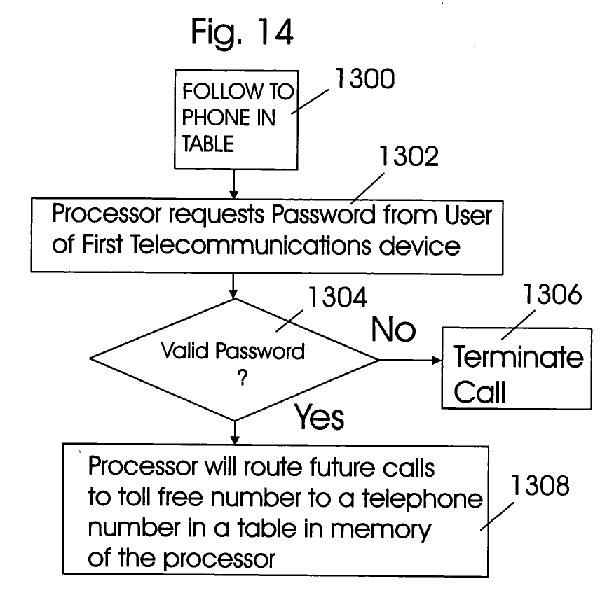

FIG. 15 shows a flow chart concerning processing for placing a telephone number on a nuisance caller list. The method of FIG. 15 starts at step 1400 where the second telecommunications device 14 calls a toll free number for the first telecommunications device 12. Next, at step 1402, the processor 16 determines if the second telecommunications device 14 is on a nuisance caller list in the memory of the processor 16. If the answer is yes, then the processor 16 sends the call to voice mail at step 1404. The voice mail data is stored in memory of the processor 16.

If the second telecommunications device 14 is not on a nuisance caller list in the memory of the processor 16, then at step 1406 the processor 16 permits the call to go through. At step 1408 the processor checks to see if the user has pressed the key #9 on the first telecommunications device 12 before the user has hung up. If not, then the call ends at step 1410. If the user has pressed the key #9 then the processor 16 stores the second telecommunications device 14 telephone number in the nuisance list in the memory of the processor 16, at step 1412. The call then ends at step 1414.

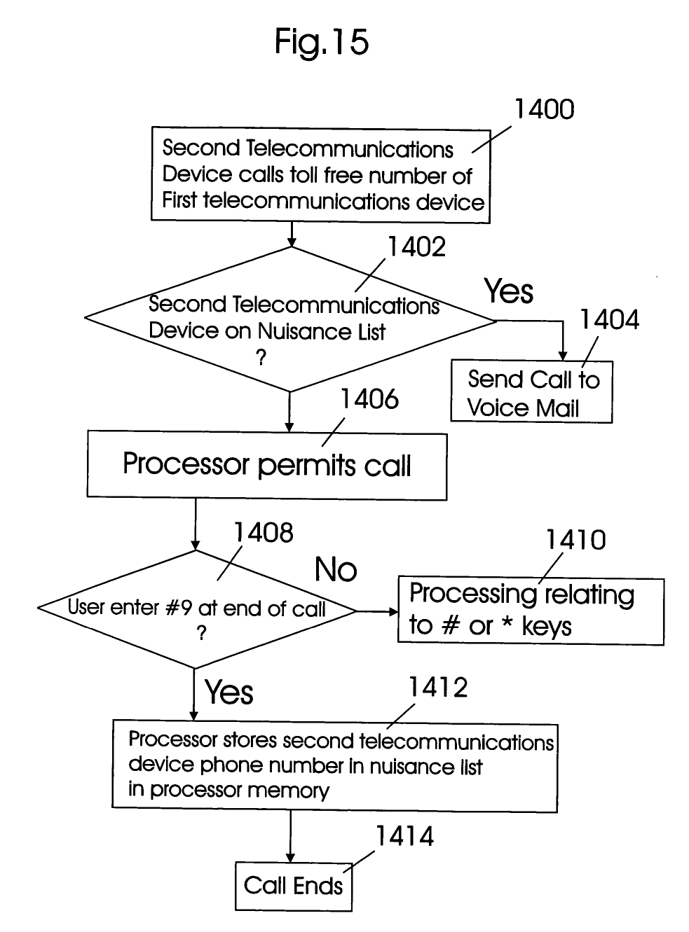

FIG. 16 shows a flow chart 1500 concerning processing relating to the # or the * keys. The entry point for the processing in step 1502. In this example a user is engaged in a telephone conversation. The user may be using, for example, first telecommunications device 12 of FIG. 1. The processor 16 determines whether the user pressed or entered the # key at step 1504. Typically, when a telephone conversation has ended such that the other party has hung up, but before the user hangs up, a user may enter or press the # key on the first telecommunications device 12. If the user has pressed or entered the #key then the processor 16 requests the user to enter a six digit identification number for the conversation or call at step 1508. The user enters the six digit identification number into the first telecommunications device at step 1510. The processor 16 will store the six digit identification number in the memory of the processor 16 and associate the six digit identification number with the conversation or call.

If the user has not pressed the #key, the processor 16 next determines at step 1506 if the user pressed the *key after the other party has hung up but before the user has hung up. If the user has entered the *key, then the processor 16 will assign a six digit identification number to the conversation or call and will speak the number to the first telecommunications device 12, at step 1512.

To record a conversation a user may end a conversation by saying good by, but not hanging up. Instead, the user may push either the * key or the # key on your phone pad of, for example, the first telecommunications device 12. Either on of these keys will cause the processor 16 to first hang up the phone of the other party. Then the processor 16 will interact with the user of the first telecommunications device directly to manage the recording of the call just completed as shown and described with reference to FIG. 12.

Typically, if the user pushed the * key the system will automatically speak a 6 digit number. This number, we call the conversation number uniquely identifies the call and as you will see later, is used when you want to listen to the conversation. Typically, the user will need to jot down two pieces on information regarding the call. The user needs the six digit conversation number as well as the date on the call. Typically the processor 16 will allow the user to hear the call when the conversation number is provided, and will also allow the user to be able to allow the other party to hear the conversation as well.

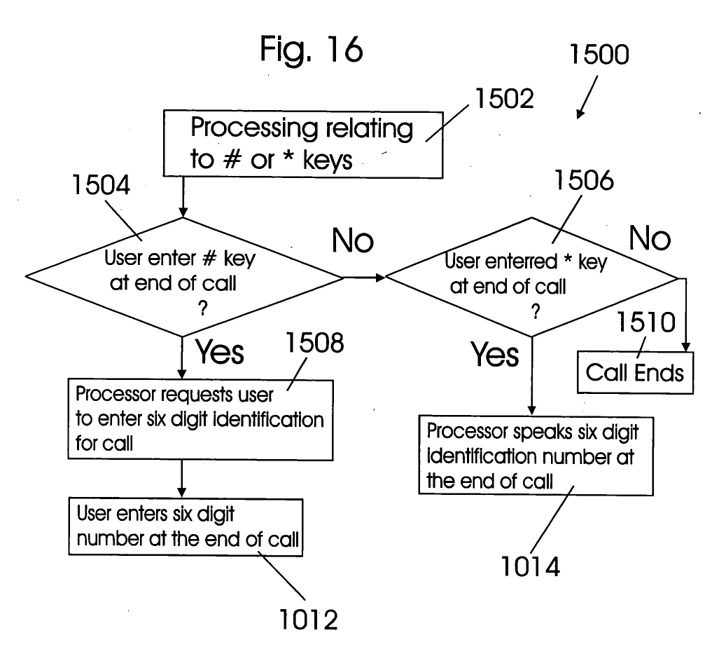

FIG. 17 shows a flow chart 1600 concerning storing a call record and making a recorded conversation available. At step 1602 the processor 16 stores in its memory a call record for each call made with a toll free number. This includes both inbound calls, where someone else calls the toll free number and outbound calls, where the toll free number is used to call another number. At step 1604 the processor 16 makes a recorded conversation available on the Internet so it can be listened to by the account owner.

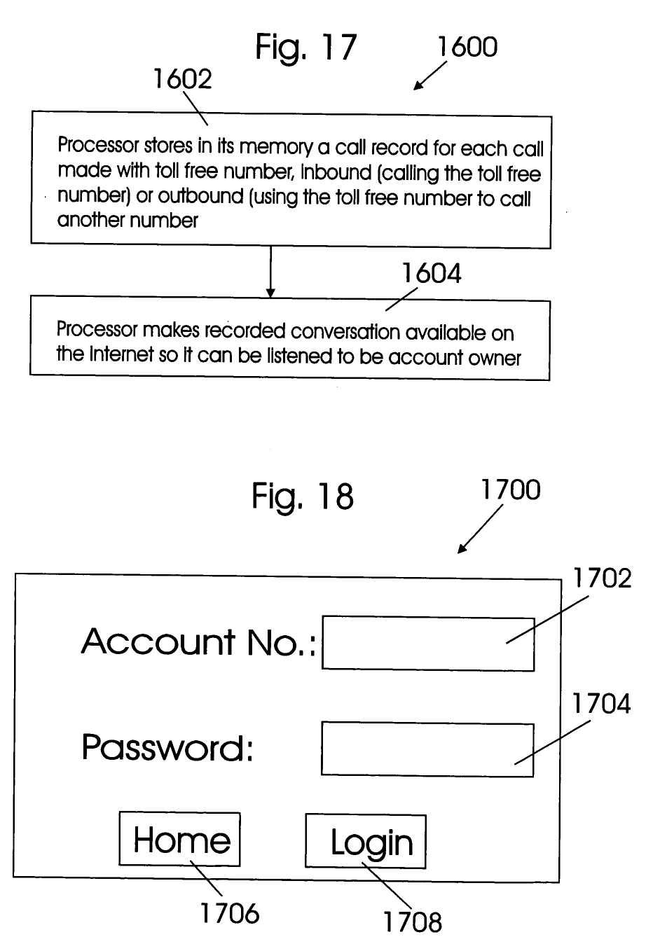

FIG. 18 shows a menu 1700 for logging into a system for retrieving information about telephone calls and conversations. The menu 1700 includes entry field 1702 for entering an account number and entry field 1704 for entering a password. The menu 1700 also includes field 1706 for going back to the home page of a web site and field 1708 for logging into the system. The menu 1700 may be displayed on a computer monitor, which may be part of a personal computer. The menu 1700 may be displayed on an Internet web page.

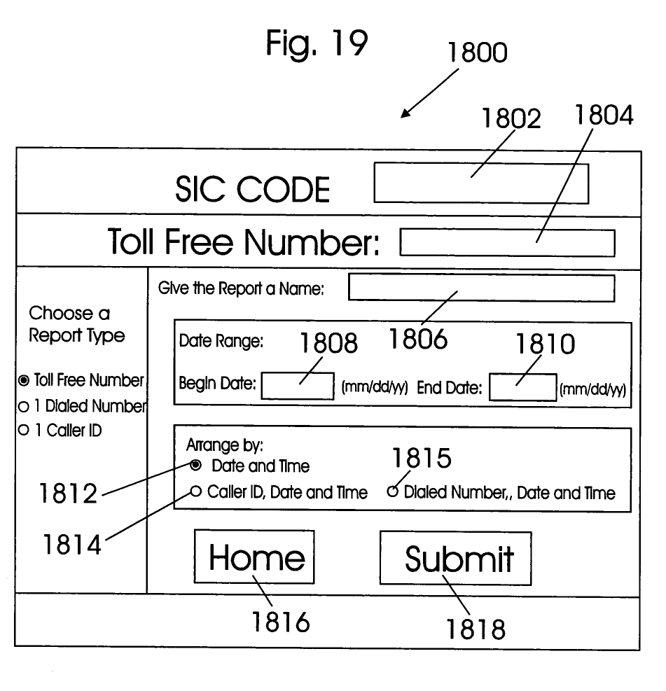

FIG. 19 shows a menu 1800 for selecting a report type and for inputting other criteria for displaying information about telephone calls and conversations. The menu 1800 may be displayed on a computer monitor of a personal computer. The menu 1800 includes a field 1802 for entering a business identification code. The menu 1800 includes a field 1804 for entering a toll free number, a field 1806 for entering a report name, a field 1808 for entering a beginning date of a date range, and a field 1810 for entering an end date of a date range. The menu 1800 also includes a field 1812 for indicating that the report data should be arranged by date and time. The menu 1800 also includes a field 1814 for indicating that the report data should be arranged by caller ID, date, and time, and a field 1815 for indicating that the report data should be arranged by dialed number, date, and time. The menu 1800 also includes a field 1816 identified as “Home” for clicking on to go back to a home page of a web site, and a field 1818 identified as “Submit” for clicking on to submit data to a web site.

If one of the follow me feature shown by FIGS. 12-14 is used then, in one embodiment, the processor 16 will cause all of the user's voice mail to come to the same telecommunications device. That means the user wouldn't have a separate voice mail on the user's cell phone, home telephone or business telephone. The processor 16 makes the voice mail available on the Internet so that a user can listen to the voice mail on the web.

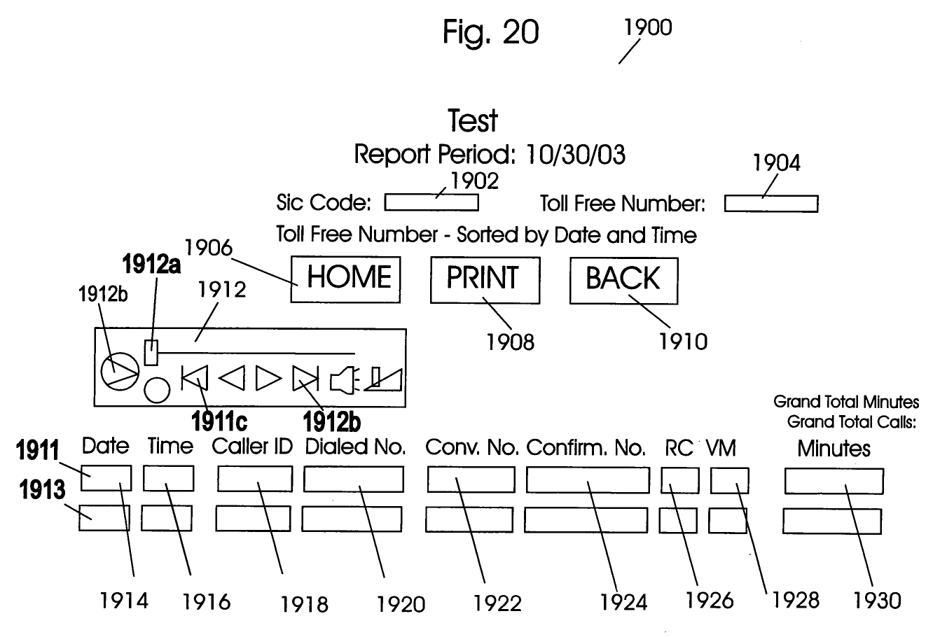

FIG. 20 shows a web report 1900. The web report 1900 may have a plurality of rows of data, such as the rows 1911 and 1913. Each row may include date (in field 1914) and time (in field 1916) of a phone call to the “800” number or using the “800” number or a private phone designated for the “800” number. Each row may include caller identification (ID) of the caller who called the “800” number in field 1918. Each row may include a dialed number (No.) in field 1920 to indicate what the number dialed was. Each row may include a conversation (conv.) number (No.) in field 1922 which is a number identifying a particular telephone conversation. Each row, such as row 1911, may include a confirmation number (No.) in field 1924 for someone to call to hear the particular phone conversation. Each row, may include a field 1926 which may have a check mark or X to indicate that the particular conversation was recorded. Each row may include a field 1928 which may have a check mark to indicate that a voice mail message was left. Finally, each row may have a field 1930 showing a total of minutes for a call.

A user may simply click on the symbol such as a check mark or underlined R under the RC field 1926 and then the user can hear the conversation via the Internet. Field 1912 may include tape recorder controls such as volume 1912a, play button 1912b, rewind 1912c, and fast forward 1912d. These tape recorder controls can be operated by a computer mouse. In addition to viewing the report 1900 in FIG. 20, on the screen, the user can print the report.

The processor 16 may also provide a mid-call interrupt which may put a caller on hold or play music for a caller, while providing information to the user of telecommunications device 12 concerning a prior call from the caller.

The processor 16 may also provide various end call features. The processor 16, may for example, hang-up the caller in response to a key entered by the user, while leaving the user's telecommunications device 12 connected to the processor 16. The processor 16 may then give the user options such as for example, adding the caller to a nuisance list, making a recording choice, hearing a recorded conversation number, tagging a recorded conversation, or allowing the user of telecommunications device 12 to enter an opinion of the call into memory of the processor 16.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a processor;
wherein the processor receives a toll free call from a first telecommunications device, wherein the toll free call was generated by dialing a toll free number on the first telecommunications device;
wherein the processor generates a first ring after receiving the toll free call and transmits the first ring to the first telecommunications device;
wherein the processor determines if a key was pressed on the first telecommunications device following the first ring but before a second ring;
wherein if a key was not pressed on the first telecommunications device the processor allows the toll free call to go through to a second telecommunications device;
and wherein if a key was pressed the processor audibly communicates one or more options to the first telecommunications device and waits for a user of the first telecommunications device to provide a response to the one or more options.

2. The apparatus of claim 1 wherein
the one or more options are comprised of an audible request from the processor to the first telecommunications device for the user of the first telecommunications device to enter a password into the first telecommunications device.

3. The apparatus of claim 1 wherein
the one or more options are comprised of an audible request from the processor to the first telecommunications device for the user of the first telecommunications device to enter a telephone number to call.

4. The apparatus of claim 1 wherein
the processor plays back voice mail messages to the first telecommunications device.

5. The apparatus of claim 1 wherein
the processor routes future calls to the toll free number to the first telecommunications device.

6. The apparatus of claim 1 wherein
the processor routes future calls to the toll free number to a further telephone number, wherein the further telephone number is stored in a memory of the processor.

7. The apparatus of claim 1 wherein
the processor routes future calls to the toll free number to a further telephone number entered by a user into the first telecommunications device.

8. The apparatus of claim 1 wherein
the processor causes data concerning the toll free call to be displayed on an Internet web page.

9. An apparatus comprising
a processor; and
wherein the processor receives a toll free call from a first telecommunications device having a first telephone number, wherein the toll free call was generated by dialing a toll free number on the first telecommunications device;
wherein the processor determines if the first telephone number is on a nuisance list;
wherein if the first telephone number is on the nuisance list then the processor causes the toll free call to be automatically routed to voice mail; and
wherein if the first telephone number is not on the nuisance list, then the processor causes the toll free call to be routed to a second telecommunications device.

10. An apparatus comprising
a processor; and
wherein the processor receives a toll free call from a first telecommunications device having a first telephone number, wherein the toll free call was generated by dialing a toll free number on the first telecommunications device;
wherein the processor routes the toll free call to a second telecommunications device;
wherein the processor receives an input from the second telecommunications device indicating that the first telephone number of the first telecommunications device should be placed on a nuisance list in a memory of the processor;
and wherein the processor places the first telephone number of the first telecommunications device on the nuisance list in the memory of the processor.

11. A method comprising:
receiving a toll free call from a first telecommunications device, wherein the toll free call was generated by dialing a toll free number on the first telecommunications device;
generating a first ring after receiving the toll free call and transmitting the first ring to the first telecommunications device;
determining if a key was pressed on the first telecommunications device following the first ring but before a second ring;
allowing the toll free call to go through to a second telecommunications device if a key was not pressed on the first telecommunications device;
audibly communicating one or more options to the first telecommunications device if a key was pressed on the first telecommunications device
and waiting for a user of the first telecommunications device to provide a response to the one or more options.

12. The method of claim 11 wherein
the one or more options are comprised of an audible request to the first telecommunications device for the user of the first telecommunications device to enter a password into the first telecommunications device.

13. The method of claim 11 wherein
the one or more options are comprised of an audible request to the first telecommunications device for the user of the first telecommunications device to enter a telephone number to call.

14. The method of claim 11 further comprising
playing back voice mail messages to the first telecommunications device.

15. The method of claim 11 further comprising
routing future calls to the toll free number to the first telecommunications device.

16. The method of claim 11 further comprising
routing future calls to the toll free number to a further telephone number, wherein the further telephone number is stored in a memory.

17. The method of claim 11 further comprising
routing future calls to the toll free number to a further telephone number entered by a user into the first telecommunications device.

18. The method of claim 11 wherein
displaying data concerning the toll free call on an Internet web page.

19. A method comprising
receiving a toll free call from a first telecommunications device having a first telephone number, wherein the toll free call was generated by dialing a toll free number on the first telecommunications device;
determining if the first telephone number is on a nuisance list;
if the first telephone number is on the nuisance list then causing the toll free call to be automatically routed to voice mail; and
if the first telephone number is not on the nuisance list, then causing the toll free call to be routed to a second telecommunications device.

20. A method comprising
receiving a toll free call from a first telecommunications device having a first telephone number, wherein the toll free call was generated by dialing a toll free number on the first telecommunications device;
routing the toll free call to a second telecommunications device;
receiving an input from the second telecommunications device indicating that the first telephone number of the first telecommunications device should be placed on a nuisance list in a memory;
and placing the first telephone number of the first telecommunications device on the nuisance list in the memory.

21. A method comprising
determining whether a telephone call should be recorded or not based on where the telephone call originated from.

22. A method comprising
providing a greeting for an inbound telephone call from a caller, which tells the caller that the phone call is going to be recorded.

23. A method comprising
providing a telecommunications system which allows an individual to choose either to record inbound telephone calls made to a telecommunications device or not to record inbound telephone calls made to a telecommunications device.

24. The method of claim 23 wherein
the telecommunications system allows an individual to choose to record inbound calls made to a telecommunications device when the inbound calls are made from a state, of the United States, that legally permits the recording of telephone conversations when only one party is aware of the recording of the telephone conversation.

25. The method of claim 24
wherein the individual can choose to record an inbound call by pressing a key on the telecommunications device.

26. The method of claim 23
wherein the individual can choose to record an inbound call made to a telecommunications device when the inbound calls are made from a state, of the United States, that legally permits the recording of telephone conversations when only one party is aware of the recording of the telephone conversation.

27. A method comprising
determining whether a telephone call should be recorded or not based the location of a telecommunications device being called.

28. A method comprising
providing a telecommunications system which allows an individual to choose either to record outbound telephone calls made to a telecommunications device or not to record outbound telephone calls made to a telecommunications device.

29. The method of claim 28 wherein
the telecommunications system allows an individual to choose to record outbound calls made to a telecommunications device which is in a state of the United States, that legally permits the recording of telephone conversations when only one party is aware of the recording of the telephone conversation.

30. The method of claim 28
wherein the individual can choose to record an outbound call by pressing a key on the telecommunications device.

31. The method of claim 30
wherein the individual can choose to record an outbound call made to a telecommunications device, which is in a state of the United States, that legally permits the recording of telephone conversations when only one party is aware of the recording of the telephone conversation.

32. A method comprising
providing a message that alerts a first party answering a telephone call from a second party that the telephone call is going to be recorded; and
wherein only the first party can hear the message.
